(19) United States
(12) Patent Application Publication
(10) Pub. No.: US 2017/0004946 A1
(43) Pub. Date: Jan. 5, 2017

(54) Conductive Composite and Circuit Protection Device Including a Conductive Composite

(71) Applicant: Tyco Electronics Corporation, Berwyn, PA (US)

(72) Inventors: Edward W. Rutter, JR., Pleasanton, CA (US); Ann O. Banich, Menlo Park, CA (US); Jaydip Das, Cupertino, CA (US); Chun-Kwan Tsang, Morgan Hill, CA (US); Kavitha Bharadwaj, Fremont, CA (US); Ting Gao, Palo Alto, CA (US); Jianhua Chen, Sunnyvale, CA (US); James Toth, San Carlos, CA (US)

(73) Assignee: Tyco Electronics Corporation, Berwyn, PA (US)

(21) Appl. No.: 14/788,530

(22) Filed: Jun. 30, 2015

(51) Int. Cl. H01H 85/055

(52) U.S. Cl. CPC H01H 85/055

(57) ABSTRACT

Conductive composite compositions and circuit protection devices including a conductive composite composition are disclosed. The conductive composite composition includes a polymer material, a plurality of conductive particles, and a high melting point additive. The high melting point additive comprises at least 1% of the conductive composite, by volume of the total composition. The circuit protection device includes a body portion comprising a conductive composite composition, the conductive composite composition comprising a polymer material, a plurality of conductive particles, and at least 1%, by volume, of a high melting point additive loaded in the polymer material, and leads extending from the body portion, the leads arranged and disposed to electrically couple the circuit protection device to an electrical system. Also provided is a method of forming a conductive composite.

### FIELD OF THE INVENTION

The present invention is directed to conductive composites and circuit protection devices including conductive composites. More particularly, the present invention is directed to resettable thermal devices and composite formulations therein.

### BACKGROUND OF THE INVENTION

Various electronic circuits include components that help protect against damage from overcurrent faults. For example, one type of circuit protection device includes a resettable device, or polymeric positive temperature coefficient (PPTC) device. These PPTC devices generally include a conductive composite formulation, which increases the resistance of the device in response to increasing temperatures, such as increases resulting from high current.

Typically, the conductive composite formulation includes a polymer loaded with conductive particles. When the polymer is heated to a temperature above the switching temperature of the device the polymer melts, causing expansion of the polymer and separation of the conductive particles. The separation of the conductive particles increases the resistance of the device, providing overcurrent protection of the circuit.

However, due to aging and/or decreased trip endurance, the protective properties of some devices deteriorate over time. For example, oxidation of the conductive particles and/or degradation of the polymer may increase the resistance of the device. Current methods of addressing the deterioration of the protective properties, e.g. coating the device to limit oxygen ingress, each suffer from one or more drawbacks that limit their applicability and/or efficiency.

Conductive composites and circuit protection devices that show one or more improvements in comparison to the prior art would be desirable.

### BRIEF DESCRIPTION OF THE INVENTION

In an embodiment, a conductive composite composition includes a polymer material, a plurality of conductive particles, and a high melting point additive. The high melting point additive comprises at least 1% of the conductive composite, by volume of the total composition.

In another embodiment, a method of forming a conductive composite composition includes providing a polymer material, loading the polymer material with, by volume of the total composition, between about 20% and about 50% conductive particles, loading the polymer material with, by volume of the total composition, at least 1% high melting point additive, and crosslinking the polymer material to form a polymer matrix of the conductive composite. The crosslinking is at a dose of the equivalent of at most 80 Mrads.

In another embodiment, a circuit protection device includes a body portion comprising a conductive composite composition, the conductive composite composition comprising a polymer material, a plurality of conductive particles, and at least 1%, by volume, of a high melting point additive loaded in the polymer material, and leads extending from the body portion, the leads arranged and disposed to electrically couple the circuit protection device to an electrical system.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 shows a schematic view of a circuit protection device, according to an embodiment of the disclosure.

FIG. 2 shows a section view of a circuit protection device, according to an embodiment of the disclosure.

Wherever possible, the same reference numbers will be used throughout the drawings to represent the same parts.

### DETAILED DESCRIPTION OF THE INVENTION

Provided are conductive composite compositions (also referred to as “conductive composites”) and circuit protection devices including conductive composites. Embodiments of the present disclosure, for example, in comparison to concepts failing to include one or more of the features disclosed herein, provide improved electrical performance, i.e. one or more of decrease electrical resistance, decrease polymer degradation, decrease polymer aging, facilitate maintenance of initial performance properties including resistance, increase trip endurance, maintain trip endurance properties for an increased amount of time, increase device lifecycle, increase efficiency, permit other advantages and distinctions that will be apparent from the present disclosure, or permit any suitable combination thereof.

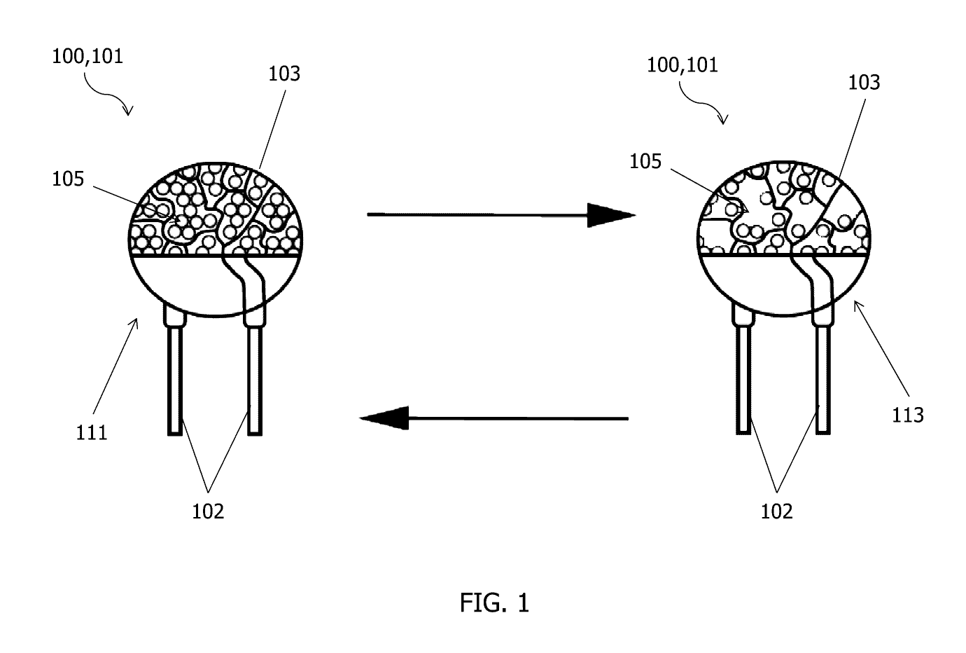

FIG. 1 shows an embodiment of a circuit protection device 100, for example, including a polymeric positive temperature coefficient (PPTC) device 101. Leads 102 are secured to the circuit protection device 100 and configured to electrically couple the circuit protection device 100 to a circuit or other electrical system. For example, the leads 102 may include conductive metal or alloy wires configured for insertion into a printed circuit board. Other suitable leads include conductive materials in any form capable of being detachably or integrally secured to an electrical system, such as, but not limited to, ribbons, straps, terminals, or a combination thereof.

The leads 102 facilitate a flow of electrical current through the circuit protection device 100. In one embodiment, the leads 102 extend from a body portion 103 of the PPTC device 101, facilitating the flow of electrical current through the body portion 103. Although shown as a circular body portion in FIG. 1, as will be appreciated by those skilled in the art, the body portion 103 of the PPTC device 101 is not so limited, and may include any other suitable geometry or configuration. Other suitable geometries or configurations include, but are not limited to, a rectangular body portion, a square body portion, a semi-spherical body portion, a triangular body portion, and/or any other geometrically shaped body portion.

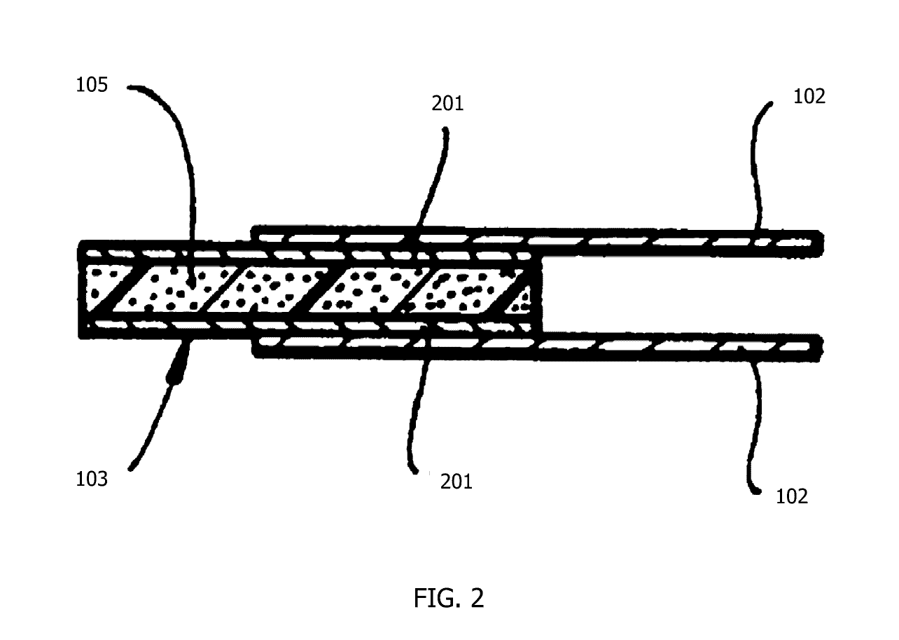

The PPTC device 101 also includes a conductive composite 105 positioned in contact with the body portion 103. The conductive composite 105 is positioned within the body portion 103, encapsulated by the body portion 103 (see FIG. 1), positioned between two or more plates 201 that form the body portion 103 (see FIG. 2), or a combination thereof. For example, as illustrated in FIG. 2, the conductive composite 105 is positioned between two plates 201 that form the body portion 103, each of the plates 201 having one of the leads 102 extending therefrom.

According to one or more of the embodiments disclosed herein, the conductive composite 105 includes any suitable material for providing repeated changes in resistivity in response to changes in temperature, such as, but not limited to, temperature changes due to the flow of electrical current through the conductive composite 105, an ambient temperature, a temperature of the circuit protection device 100, a temperature of the circuit, or a combination thereof. For example, in one embodiment, the conductive composite 105 includes a polymer material loaded with conductive particles and optionally at least one additive. In another embodiment, the polymer material, the conductive particles, and the optional at least one additive determine a trip temperature of the conductive composite 105. In a further embodiment, the conductive composite 105 provides repeated changes in resistivity through melting and recrystallization of the polymer material in response to changes in the temperature above and below the trip temperature. As used herein, the term “trip temperature” relates to the melting point of the polymer material.

At temperatures below the trip temperature, the polymer material is in a crystalline form that holds a plurality of the conductive particles in electrical contact with each other. The plurality of conductive particles held in electrical contact with each other provides a first resistance of the circuit protection device 100, the first resistance corresponding to a low resistance state 111 of the PPTC device 101 (i.e., when the device is in a low temperature state, below the melting temperature of the polymer material). Alternatively, at temperatures equal to or above the trip temperature, the polymer material is melted, expanded, and/or in an amorphous form that separates the plurality of conductive particles. Separating the plurality of conductive particles provides a second resistance of the circuit protection device 100, the second resistance corresponding to a high resistance state 113 of the PPTCE device 101 (i.e., when the device is in a high temperature state, at or above the melting temperature of the polymer material). The second resistance, which is reflected in a high resistivity of the conductive composite 105, is greater than the first resistance, which is reflected in a low resistivity of the conductive composite 105, and provides a relatively decreased current flow through the PPTC device 101. The relatively decreased current flow through the PPTC device 101 decreases current flow within a circuit to help protect components that are downstream in the circuit.

In one embodiment, changing from the low resistance state 111 to the high resistance state 113 includes a rapid and/or significant change in the resistivity of the conductive composite 105. As used herein, rapid and/or significant changes in resistivity include an R₁₄ value of at least 2.5, an R₃₀ value of at least 6, and/or an R₁₀₀ value of at least 10, where R₁₄, R₃₀, and R₁₀₀ are the ratios of the resistivities at the end and beginning of a 14° C. range, a 30° C. range, and a 100° C. range, respectively. In another embodiment, the conductive composite 105 has a resistivity of less than 10 ohm-cm. Additionally or alternatively, the conductive composite has a resistivity of less than 5 ohm-cm, less than 1 ohm-cm, less than 0.1 ohm-cm, and/or less than 0.05 ohm-cm.

In certain embodiments, the polymer material is a semi-crystalline polymer. Semi-crystalline polymers are characterized by a melting temperature, which is the temperature above which the crystalline domains, or crystallites, in the polymer melt, causing expansion of the polymer material. Suitable semi-crystalline polymers include, but are not limited to, thermoplastics, including polyolefins, such as polypropylene, polyethylene, or copolymers of ethylene and propylene. Other suitable semi-crystalline polymers may also include copolymers of at least one olefin and at least one non-olefin monomer copolymerisable therewith. Examples of these copolymers include poly(ethylene-co-acrylic acid), poly(ethylene-co-ethyl acrylate), poly(ethylene-co-butyl acrylate), and poly(ethylene-co-vinyl acetate). Suitable thermoformable fluoropolymers include polyvinylidene fluoride, and ethylene/tetrafluoroethylene copolymers and terpolymers.

Additionally or alternatively, the polymer material includes a blend of two or more polymers, the blend providing desired physical, thermal, or electrical properties, such as flexibility, adhesion (e.g., to metal foil electrodes and/or conductive particles), or high temperature capability. For example, when the host polymer is a semi-crystalline polymer, secondary polymers that may be blended with the semi-crystalline polymer include, but are not limited to, elastomers, amorphous thermoplastic polymers, or other semi-crystalline polymers. More specifically, in one embodiment, the circuit protection device 100 includes a semi-crystalline polymer such as polyethylene, high density polyethylene (HDPE), low density polyethylene (LDPE), and/or a mixture of HDPE and a copolymer. In another embodiment, the conductive composite 105 of the circuit protection device 100 includes, by volume, between about 30 and 80% polymer material, between about 35 and 75% polymer material, between about 40% and about 70% polymer material, or any combination, sub-combination, range, or sub-range thereof.

In one embodiment, the polymer material includes a low melt index polymer, such as, for example, a low melt index polyethylene. As used herein, the term “high melt index” refers to any polymer having a melt index equal to or greater than 6.0. Additionally, as used herein, the term “low melt index” refers to any polymer having a melt index equal to or less than 2.0, including, but not limited to, polymers having a melt index less than or equal to 1.0, less than or equal to 0.5, less than or equal to 0.3, less than or equal to 0.2, less than or equal to 0.1, less than or equal to 0.05, less than or equal to 0.04, less than or equal to 0.03, less than or equal to 0.02, less than or equal to 0.01, or any combination, sub-combination, range, or sub-range thereof.

In general, relatively lower melt indexes indicate polymers having a relatively higher molecular weight and/or level of chain entanglement. One high melt index HDPE polymer includes, for example, MarFlex® 9607, available from Chevron Phillips Chemical Company, which has a melt index of 6.5. Suitable low melt index HDPE polymers include, but are not limited to, MarFlex® 9659, also available from Chevron Phillips Chemical Company, which has a melt index of 1.0, Petrothene™ LB832, available from USI, having a melt index of 0.26, and/or Alathon® L4904, available from LyondellBasell Industries, which has a melt index of 0.040.

As compared to relatively higher melt index polymers, the low melt index polymers increase trip endurance (i.e., the ability of the device to withstand a specified current and voltage in the high resistance state 113 for an extended period) and/or survival of the circuit protection device 100. For example, in one embodiment, a CuSn based system including the MarFlex® 9607 polymer having a melt index of 6.5 exhibited a trip endurance of about 21 hours, while the CuSn based system including the Alathon® L4904 polymer having a melt index of 0.040 exhibited a trip endurance of greater than 160 hours. In another example, none of the devices in a WC based system including the MarFlex® 9607 polymer survived more than 1 week, while about 10% of the devices including the MarFlex® 9659 polymer survived at least two weeks, about 40% of the devices including the Petrothene™ LB832 polymer survived at least two weeks, and about 80% of the devices including the Alathon® L4904 polymer survived at least two weeks. While not wishing to be bound by theory, in contrast to current conductive composites that use high melt index polymers to provide lower viscosity processing, the low melt index polymers according to one or more of the embodiments disclosed herein are believed to provide increased dispersion uniformity of the conductive particles and/or decreased component mobility within the PPTC device 101.

The conductive particles within the conductive composite 105 are selected to provide a desired resistivity in the low resistance state 111. In one embodiment, the conductive particles include any particles having a resistivity of less than 10⁻³ ohm-cm, less than 10⁻⁴ ohm-cm, and/or less than 10⁻⁵ ohm-cm. In another embodiment, the conductive composite 105 of the circuit protection device 100 includes, by volume of the total composition, between about 20 and 60% conductive particles, between about 25 and 55% conductive particles, between about 30 and 50% conductive particles, between about 40 and 50% conductive particles, or any combination, sub-combination, range, or sub-range thereof.

Suitable conductive particles include, but are not limited to, metals, including tungsten (W), nickel (Ni), copper (Cu), silver (Ag), titanium (Ti), or molybdenum (Mo); alloys or intermetallics, including copper-tin (CuSn); metallic ceramics, including tungsten carbide (WC) or titanium carbide (TiC); carbon-based materials, including carbon (C), carbon black, or graphite; or a combination thereof. Additionally or alternatively, the conductive particles may be coated. For example, the coated particles may include a non-conductive material, such as glass or ceramic, or a conductive material, such as carbon black and/or another metal or metal alloy, that has been at least partially coated with a coating material that provides a desired resistivity. The coating material includes any material having the same, substantially the same, or a different resistivity as compared to the conductive or non-conductive material being coated. Suitable coating materials include, but are not limited to, a metal, a metal oxide, carbon, or a combination thereof.

In one embodiment, a particle size and/or shape of the conductive particles is selected to provide the desired resistivity in both the low resistance state 111 and the high resistance state 113. For example, spherical particles may provide increased electrical stability and/or larger resistance increases as compared to particles in the form of flakes or fibers. Additionally or alternatively, it has unexpectedly been discovered that a predetermined range of particle sizes provides improved or maintained electrical properties, such as cycle life (i.e., the ability of a device to survive successive cycles at a specified current and voltage without failure), and electrical reproducibility. Improved properties includes, but is not limited to, decreased loss of PTC anomaly height, increased reliability, increased trip endurance, and/or increased lifespan of the PPTC device 101 through repeated cycling between the low resistance state 111 and the high resistance state 113 and/or extended exposure to increased temperatures. As used herein, the term “PTC anomaly height” refers to an amount of increase in resistance between the low resistance state 111 and the high resistance state 113.

For certain conductive particles, such as WC, the predetermined range includes a particle size distribution in which the average particle size (D50) is between 1.0 and 2.5 μm (i.e. “microns”). These conductive particles provide improved device performance as compared to particle sizes of less than 1.0 micron and/or greater than 2.0 microns. In one embodiment, the particle size distribution is characterized by values of D10, D50, and D90 corresponding to the size values where 90%, 50%, and 10% of the particles, respectively, are larger than the stated value. Therefore for a particle size distribution having a D50 value of 1.8 microns, 50% of the particles have a particle size greater than 1.8 microns. In another embodiment, the particle size distribution is characterized by D50 value is between 1.1 and 2.2 microns. In another embodiment, the D50 value is between 1.2 and 2.0 microns. Although described above with regard to WC particles, as will be appreciated by those skilled in the art, suitable particle sizes and shapes may vary between different conductive particle materials.

Not wishing to be bound by theory, it is believed that particles having a size of less than 1.0 micron exhibit increased agglomeration as compared to particles having a size equal to or greater than 1.0 micron. Again, not wishing to be bound by theory, it is believed that the increased agglomeration exhibited by the particles having a size of less than 1.0 micron increases the first resistance of the circuit protection device 100 after one or more exposures of the conductive composite 105 to a temperature above the melting point of the polymer material and thus to the resistive state 113, e.g., during the assembly process during which the circuit protection device 100 is reflow-soldered onto a substrate (a “reflow”). Additionally, it is believed that particles having a size of greater than 2.5 microns exhibit both an increased initial resistivity in the conductive composite as compared to the conductive particles within the predetermined range of between 1.0 and 2.5 microns, as well as increasing resistivity after each of the one or more reflows of the conductive composite 105. Using a subtractive technique to remove large particles can help increase the electrical performance of the device 100.

In contrast, the conductive composite 105 including the conductive particles having a size within the predetermined range maintain or substantially maintain the first resistance of the circuit protection device 100 after one or more temperature excursions, such as solder reflow of a device onto a circuit board. By maintaining or substantially maintaining the first resistance of the circuit protection device 100, the conductive composite 105 including the conductive particles having a size within the predetermined range decreases aging, i.e. an increased resistance, of the circuit protection device 100. For example, as compared to particles having a size outside of the predetermined range, the conductive composite 105 including the conductive particles having a size within the predetermined range decreases loss of PTC anomaly height, decreases changes in current flow through the conductive composite 105, decreases changes in heating of the conductive composite 105 due to current flow therethrough, increases reliability, or a combination thereof. Additionally or alternatively, as compared to conductive particles having a size of less than 1.0 micron, the conductive composite 105 including the conductive particles having a size within the predetermined range decreased or eliminated failure during cycle life, had an increased amount of polymer free volume, or a combination thereof.

In one embodiment, the conductive composite 105 includes a high melting point additive. As used herein, the term “high melting point additive” refers to any material having a melting point of at least 55° C. In another embodiment, the high melting point additive is loaded in the polymer material at an amount of at least 1% by volume of the total composition, an amount of at least 2% by volume of the total composition, an amount of at least 3% by volume of the total composition, an amount of at least 4% by volume of the total composition, an amount of at least 5% by volume of the total composition, an amount of at least 6% by volume of the total composition, between about 1% and about 6% by volume of the total composition, between about 1% and about 4% by volume of the total composition, between about 4% and about 6% by volume of the total composition, or any combination, sub-combination, range, or sub-range thereof. In a further embodiment, the high melting point additive includes an oxidation rate that is greater than an oxidation rate of the conductive particles and/or the polymer material of the conductive composite 105. The high melting point additive increases electrical performance of the conductive composite 105 such as, for example, by decreasing or eliminating degradation of the conductive particles and/or the polymer material.

For example, the oxidation rate of the high melting point additive may be greater than the oxidation rate of both the conductive particles and the polymer material. Selecting the high melting point additive having an oxidation rate that is greater than the oxidation rate of both the conductive particles and the polymer material facilitates oxidation of the high melting point additive before the conductive particles and the polymer material, which decreases or eliminates oxidation of the conductive particles and the polymer material until the high melting point additive is completely consumed. By decreasing or eliminating oxidation of the conductive particles and the polymer material, the high melting point additive decreases or eliminates increases in the first resistance of the conductive composite 105, decreases or eliminates loss of PTC anomaly height, decreases or eliminates other effects of aging, or a combination thereof.

In another example, the oxidation rate of the high melting point additive is greater than the oxidation rate of either the polymer material or the conductive particles and less than the oxidation rate of the other. Selecting the high melting point additive having an oxidation rate that is greater than the oxidation rate of the polymer material, for example, and less than the oxidation rate of the conductive particles, permits oxidation of the conductive particles while decreasing or eliminating oxidation and/or aging of the polymer material until the high melting point additive is completely consumed. Although oxidation of the conductive particles may increase the first resistance of the conductive composite 105, by decreasing or eliminating oxidation of the polymer material the high melting point additive decreases or eliminates loss of PTC anomaly height, decreases or eliminates additional increases in the first resistance due to deterioration of the polymer material, decreases or eliminates other effects of polymer aging, or a combination thereof.

Preferred suitable high melting point additives include, but are not limited to, any additive having a melting point of at least 82° C. One suitable high melting point additive includes, for example, 1,2-dihydro-2,2,4-trimethylquinoline, which is available as Agerite® MA from Vanderbilt Chemicals, LLC in Norwalk, Conn., having a melting point of 82° C. In addition to decreasing or eliminating degradation of the conductive composite 105, the 1,2-dihydro-2,2,4-trimethylquinoline provides lubricating properties leading to improved dispersion of the conductive particles and decreased resistivity of the conductive composite. Another suitable high melting point additive includes a sterically hindered phenolic antioxidant, such as, but not limited to, pentaerythritol tetrakis(3-(3,5-di-tert-butyl-4-hydroxyphenyl)propionate), which is available as Irganox® 1010 from BASF in Florham Park, N.J., having a melting range of 110 to 125° C. Other suitable high melting point additives include, but are not limited to, other hindered phenolic antioxidants, secondary aromatic amine antioxidants, sulfurized phenolic antioxidants, oil-soluble copper compounds, phosphorus-containing antioxidants, organic sulfides, disulfides, polysulfides, or a combination thereof. Further examples include, but are not limited to, 4-4′-thiobis[2-(1,1-dimethylethyl)-5-methyl-, which is available as BNX® 358 from Mayzo in Suwanee, Ga., 2,2-methylenebis(4-methyl-6-tert-butylphenol)acrylate, which is available as BNX® 3052 from Mayzo, a hindered amine light stabilizers (HALS) type bis(2,2,6,6-tetramethyl-4-piperidyl) sebacate, or a combination thereof.

In one embodiment, forming the circuit protection device 100 includes cros slinking the polymer material to form a polymer matrix. In another embodiment, decreasing the cros slinking level during the forming of the circuit protection device 100 decreases degradation of the polymer material in the conductive composite 105 and enhances electrical performance. Suitable crosslinking levels for the forming of the polymer matrix in the circuit protection device 100 include, but are not limited to, less than or equal to 100 megarads (Mrads), less than or equal to 80 Mrads, less than or equal to 75 Mrads, less than or equal to 50 Mrads, less than or equal to 40 Mrads, less than or equal to 35 Mrads, less than or equal to 30 Mrads, between about 20 Mrads and about 50 Mrads, less than or equal to 25 Mrads, less than or equal to 20 Mrads, or any combination, sub-combination, range, or sub-range thereof. The crosslinking may be achieved through any suitable method, such as, but not limited to, electron beam irradiation, gamma irradiation, or chemical crosslinking. For example, a CuSn based system formed with an electron beam dose of 20 Mrads eliminated or substantially eliminated increases in device resistance when heated at 125° C. in air, whereas the resistance of a CuSn based system formed with an electron beam dose of 50 Mrads or more significantly increased when heated at 125° C. in air.

In certain embodiments, adjusting a ratio of the conductive particles may decrease or eliminate aging of the conductive composite 105. For example, in one embodiment, increasing the Cu:Sn ratio from 3:1 to 2:1 or 3:2 decreases or eliminates increases in device resistance when heated at 85° C. in air.

The circuit protection device 100 formed according to one or more of the embodiments disclosed herein provides decreased aging and/or increased maintenance of device properties after one or more reflows. In certain embodiments, combining process parameters with different conductive composite 105 formulations further decreases aging of the conductive composite 105 and/or provides synergistic benefits that are greater than the benefits of either the process parameters or the conductive composite 105 formulations individually.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. A conductive composite composition, comprising:
a polymer material;
a plurality of conductive particles; and
a high melting point additive;
wherein the high melting point additive comprises at least 1% of the conductive composite, by volume of the total composition.

2. The conductive composite composition of claim 1, wherein the conductive composite has a resistivity of less than 10 ohm-cm.

3. The conductive composite composition of claim 1, wherein the polymer material is a semi-crystalline polymer.

4. The conductive composite composition of claim 3, wherein the semi-crystalline polymer is selected from the group consisting of thermoplastics comprising polyolefins, thermoformable fluoropolymers, copolymers of at least one olefin and at least one non-olefin, and combinations thereof.

5. The conductive composite composition of claim 3, wherein the polymer material is a high density polyethylene.

6. The conductive composite composition of claim 1, wherein the polymer material is a low melt index polymer having a melt index of less than 1.0.

7. The conductive composite composition of claim 1, wherein the polymer material comprises between about 30% and about 80% by volume of the total composition.

8. The conductive composite composition of claim 1, wherein the conductive particles comprise between about 20% and about 50% by volume of the total composition.

9. The conductive composite composition of claim 1, wherein the conductive particles have a resistivity of less than 10⁻³ ohm-cm.

10. The conductive composite composition of claim 1, wherein a D50 value of the conductive particles is between 1.0 and 2.5 microns.

11. The conductive composite composition of claim 10, wherein particles having the D50 value of between 1.0 and 2.5 microns improve electrical performance of the conductive composite as compared to particles having a D50 value below 1.0 micron and above 2.5 microns.

12. The conductive composite composition of claim 1, wherein an oxidation rate of the high melting point additive is greater than an oxidation rate of both the polymer material and the conductive particles.

13. The conductive composite composition of claim 1, wherein the high melting point additive is selected from the group consisting of 1,2-dihydro-2,2,4-trimethylquinoline, pentaerythritol tetrakis(2-(3,5-di-tert-butyl-4-hydroxyphenyl)propionate), and combinations thereof.

14. A method of forming a conductive composite composition, the method comprising:
providing a polymer material;
loading the polymer material with, by volume of the total composition, between about 20% and about 50% conductive particles;
loading the polymer material with, by volume of the total composition, at least 1% high melting point additive; and
crosslinking the polymer material to form a polymer matrix of the conductive composite;
wherein the crosslinking is at a dose of the equivalent of at most 80 Mrads.

15. A circuit protection device, comprising:
a body portion comprising a conductive composite composition, the conductive composite composition comprising:
a polymer material;
a plurality of conductive particles; and
at least 1%, by volume, of a high melting point additive loaded in the polymer material; and
leads extending from the body portion, the leads arranged and disposed to electrically couple the circuit protection device to an electrical system.
